(19) United States
(12) Patent Application Publication
(10) Pub. No.: US 2025/0187688 A1
(43) Pub. Date: Jun. 12, 2025

(54) Bicycle saddle

(71) Applicant: GLORY WHEEL ENTERPRISE CO., LTD., Taichung City (TW)

(72) Inventor: CHIEN-HAO LEE, Taichung City (TW)

(21) Appl. No.: 18/971,256

(22) Filed: Dec. 6, 2024

(30) Foreign Application Priority Data
Dec. 11, 2023 (TW) 112148131

(51) Int. Cl. B62J 1/08

(52) U.S. Cl. CPC B62J 1/08

(57) ABSTRACT

A bicycle saddle includes a saddle part and a seat tube part. The saddle part has a seating surface, an engaging surface opposite to the seating face, a thinning structure formed on the seating surface, and a reinforcing rib unit deposited at a connection area of the saddle part and the seat tube part. The seat tube part is a tubular body and is connected with the engaging surface. An accommodating space is defined in the saddle part and the seat tube part. The saddle part and the seat tube part are integrally formed with each other and made of a same material. The setup of the reinforcing rib unit and the thinning structure can improve the comfort and support for the user during riding.

### FIELD OF INVENTION

The present invention is related to a saddle, especially to a bicycle saddle.

### BACKGROUND OF THE INVENTION

A conventional seat tube and a conventional bike saddle are manufactured separately and are then combined to a bicycle frame respectively. This separate assembly approach not only allows a user to customize the seat tube and bike saddle based on their preferences, such as different models, shapes or materials, to enhance the user experience, but also makes it easier to replace or repair individual components without needing to replace the entire seat tube.

However, a long term of use for the bicycle may cause a joint between the seat tube and the bike saddle to be worn, and the friction between the bike saddle and the seat tube is reduced. Consequently, the bike saddle may easily be loosened and eventually separated from the seat tube due to vibrations and shaking when the user rides the bicycle on uneven terrain.

Based on the aforementioned reasons, there is an urgent need to develop an integrated seat tube and bike saddle that prioritizes riding comfort.

### SUMMARY OF THE INVENTION

Therefore, an object of the present invention is to provide a bicycle saddle integrally formed and providing comfort during riding.

According to the present invention, a bicycle saddle includes a saddle part and a seat tube part.

The saddle part includes a seating surface, an engaging surface opposite to the seating surface and a thinning structure formed on at least one part of the seating surface.

The seat tube part is a tubular body and is connected with the engaging surface.

The saddle part and the seat tube part are integrally formed with each other and made of a same material. An accommodating space is defined in the saddle part and the seat tube part.

The engaging surface defines a lower hollow structure.

The thinning structure is disposed along a longitudinal direction of the seating surface and corresponds to a straddling area of the saddle part.

The saddle part further includes an opening formed in the thinning structure and an elastomer filled in the accommodating space via the opening and coated with a cladding layer.

The saddle part further includes a reinforcing ring deposited at a junction of the engaging surface and the seat tube part, and an outside diameter of the reinforcing ring gradually increases toward the engaging surface.

The saddle part further includes a reinforcing rib unit. The reinforcing rib unit has at least one of outer reinforcing rib and inner reinforcing rib.

The outer reinforcing rib is a protrusive structure extending outward from the junction of the engaging surface and the seat tube part.

The reinforcing rib unit has several outer reinforcing ribs. The outer reinforcing ribs are disposed at two sides of the seat tube part along a longitudinal direction of the saddle part.

The reinforcing rib unit has at least one of inner reinforcing rib. The inner reinforcing rib is disposed radially within the tubular body of the seat tube part, and at least one end of the inner reinforcing rib connects to an inner wall of the seat tube part.

A preset angle is defined between the engaging surface and the seat tube part defines.

In the disclosure, the bicycle saddle has following effects:

The thinning structure formed on the seating surface can facilitate fitting a user's body contour, thereby providing support and comfort during prolonged riding.

The elastomer filled in the accommodating space via the opening can distribute pressure on the user's buttocks and relieve the discomfort caused by oppressive heat during riding, thereby facilitating the ease of riding and reducing a use of fiber composite material to lighten the bicycle saddle.

The cladding layer around the elastomer provides excellent abrasion resistance and weather resistance, thereby extending a service life of the bicycle saddle. The user can replace the cladding layer in a timely manner according to riding environments to avoid the elastomer from becoming damp or polluted due to unexpected situations.

The reinforcing rib unit enhances the structural stability between the saddle part and the seat tube part, improves the support of the saddle part when the user is sitting thereon, and mitigates vibration and impact on the bicycle saddle during riding to prevent from fragility and deformation, thereby facilitating the ease of riding.

### BRIEF DESCRIPTION OF THE DRAWINGS

FIG. 1 is a perspective view illustrating a first preferred embodiment of a bicycle saddle in accordance with the present invention;

FIG. 2 is another perspective view of the bicycle saddle in FIG. 1;

FIG. 3A and 3B illustrate perspective views of a second preferred embodiment of a bicycle saddle in accordance with the present invention;

FIG. 4A is a sectional view of a third preferred embodiment of a bicycle saddle in accordance with the present invention;

FIG. 4B is a cross sectional view of a third preferred embodiment of the bicycle saddle in FIG. 4A;

FIG. 4C is a top view of the bicycle saddle in FIG. 4A;

FIG. 4D is a cross sectional view of the bicycle saddle in FIG. 4C;

FIG. 4E is a top view of the bicycle saddle in FIG. 4A, illustrating the deformation of the saddle under applied pressure;

FIG. 4F is a cross sectional view of the bicycle saddle in FIG. 4E;

FIG. 5A and 5B illustrates a top view and a cross sectional view of a fourth preferred embodiment of a bicycle saddle in accordance with the present invention;

FIG. 6A is a perspective view of a fifth preferred embodiment of a bicycle saddle in accordance with the present invention;

FIG. 6B is a perspective view of a sixth preferred embodiment of a bicycle saddle in accordance with the present invention;

FIG. 7A and 7B illustrates a perspective view and a sectional view of a seventh preferred embodiment of a bicycle saddle in accordance with the present invention;

FIG. 7C and 7D illustrates a perspective view and a sectional view of an eighth preferred embodiment of a bicycle saddle in accordance with the present invention;

FIG. 8A is a perspective views of a nineth preferred embodiment of a bicycle saddle in accordance with the present invention;

FIG. 8B is a perspective views of a tenth preferred embodiment of a bicycle saddle in accordance with the present invention; and

FIG. 9 is a perspective view of an eleventh preferred embodiment of a bicycle saddle in accordance with the present invention.

### DETAILED DESCRIPTION OF THE PREFERRED EMBODIMENTS

In order to make purposes, technical solutions, and advantages of the present invention to be clearer, the following content provides some preferred embodiments in accordance with the present invention.

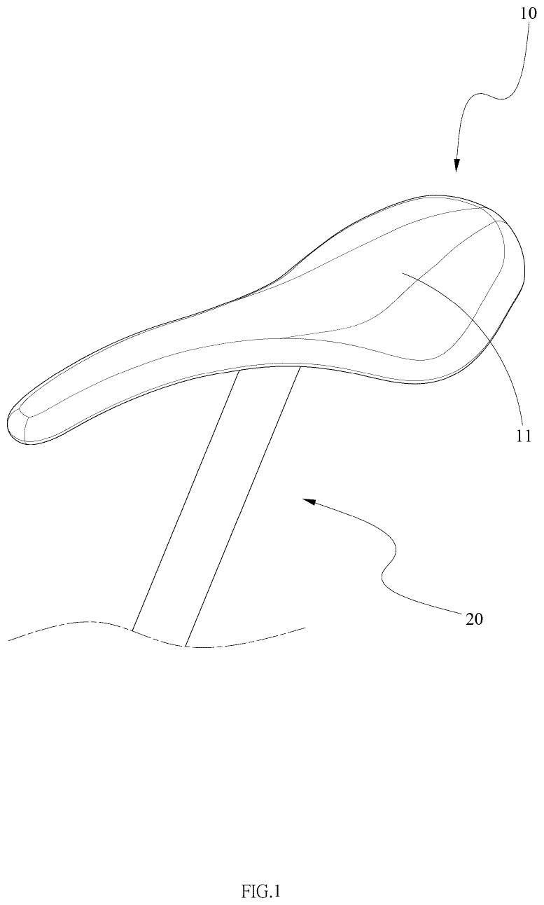

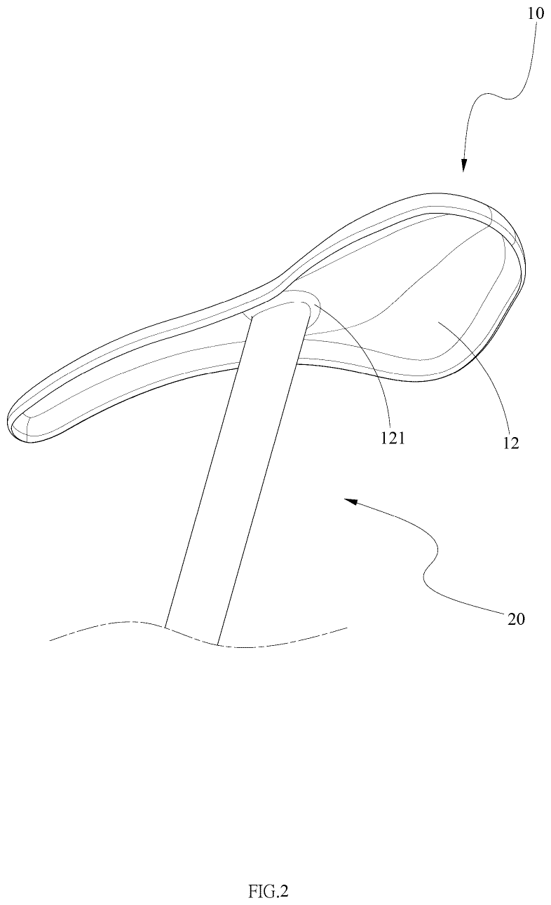

Referring to FIG. 1 and FIG. 2, a first preferred embodiment of a bicycle saddle is disclosed. The bicycle saddle includes a saddle part 10 and a seat tube part 20. The saddle part 10 and the seat tube part 20 are integrally formed with each other and made of same material. The seat tube part 20 is a tubular body and extends from the saddle part 10. The bicycle saddle is mounted on a bicycle frame of a bicycle via the seat tube part 20 and is secured to the bicycle frame with a seat clamp. The saddle part 10 provides comfort and support for a user sitting thereon while riding.

The saddle part 10 and the seat tube part 20 can be manufactured through a molding process. For example, the molding process involves following steps: preparing a mold corresponding to a shape of the bicycle saddle; and performing the molding process, such as injection molding or casting, based on the selected materials.

In this embodiment, the bicycle saddle is made of a fiber composite material. The fiber composite material includes a fiber material and a thermoplastic resin. The molding process has following steps: impregnating the fiber material with the thermoplastic resin to form a fiber prepreg at first; taking the fiber prepreg into a molding cavity of the mold, with a portion of the fiber prepreg corresponding to the seat tube part 20 wrapping around a core mold removably positioned within the molding cavity; compressing the fiber prepreg under an appropriate molding condition involving heat and pressure to make the fiber prepreg solidified; and removing the core mold subsequently. The core mold may be a rod-like or tubular structure with sufficient strength to prevent deformation of the fiber prepreg during the compression and solidification process.

The fiber material includes, but is not limited to, carbon fibers, glass fibers, ceramic fibers, aramid fibers or a combination of two or more of said.

Preferably, the fiber material is made of carbon fibers to lighten the bicycle saddle and to provide the structural support.

Preferably, the saddle part 10 can be lightened by reducing a thickness thereof, thereby a wind resistance is decreased when the user rides the bicycle and a riding speed is increased. Meanwhile, thinning the thickness of the saddle part 10 provides a streamlined appearance for the bicycle equipped with the saddle part 10, thereby the appearance of the bicycle is enhanced.

The saddle part 10 includes a seating surface 11 and an engaging surface 12 being opposite to the seating surface 11. The user sits on the saddle part 10 while riding the bicycle. The seat tube part 20 is a hollow tubular body and extends from the engaging surface 12. The saddle part 10 and the seat tube part 20 are integrally formed with each other to ensure a fixity between the saddle part 10 and the seat tube part 20, thereby vibrations and loosening between the bicycle saddle and the bicycle frame during riding can be prevented to address stability issues caused by an abrasion between t the bicycle saddle and the bicycle frame under a long term of use.

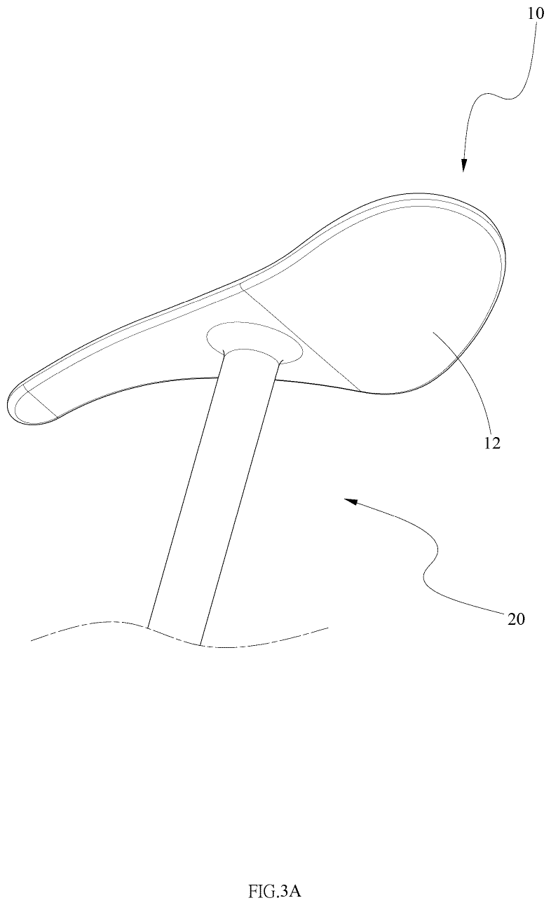

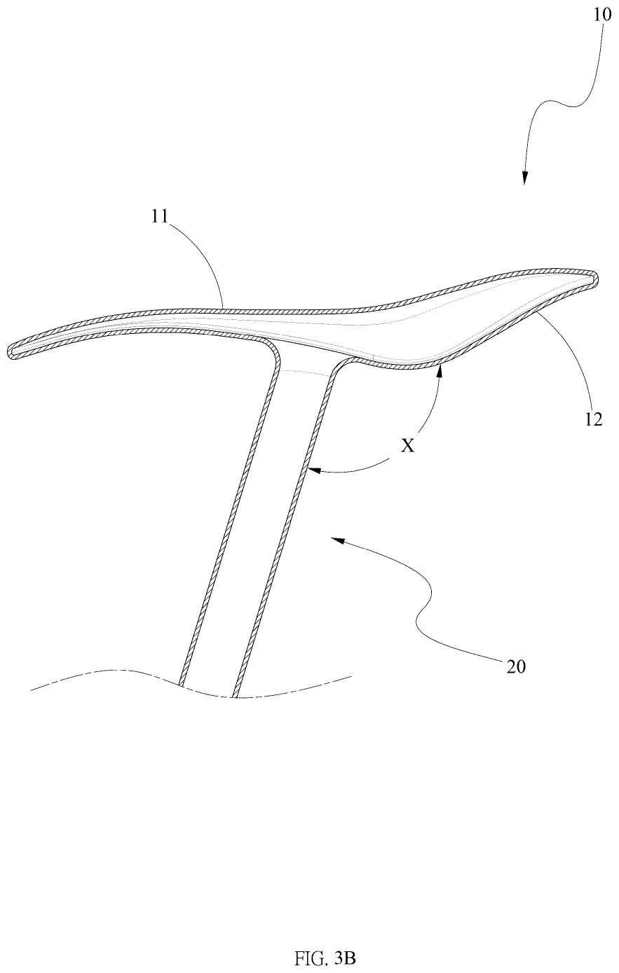

Referring to FIG. 3A and FIG. 3B, a second preferred embodiment of a bicycle saddle is disclosed. In this embodiment, the saddle part 10 has a saddle hollow structure formed between the seating surface 11 and the engaging surface 12. The seat tube part 20 extends from the engaging surface 12 with a hollow tubular body of the seat tube part 20 interconnected to the saddle hollow structure. Consequently, an accommodating space is defined in the saddle part 10 and the seat tube part 20. Additionally, the saddle hollow structure of the saddle part 10 and the hollow tubular body of the seat tube part 20 can reduce a weight of the bicycle saddle.

Notably, a preset angle X is defined between the engaging surface and an extension direction of the seat tube part 20. The preset angle X can be changed according to the user's needs. For example, the preset angle X can be changed to make the saddle part 10 tilting toward a front wheel of the bicycle when the user needs a high speed riding. Tilting the saddle part 10 forward brings the user's body closer to a handle of the bicycle to result in reducing the wind resistance during riding and to increase the riding speed. Additionally, a forward-leaning posture allows the user's center of gravity to be closer to pedals of the bicycle to enable the user to pedal more efficiently, to reduce an energy required for riding, and to prolong a riding distance.

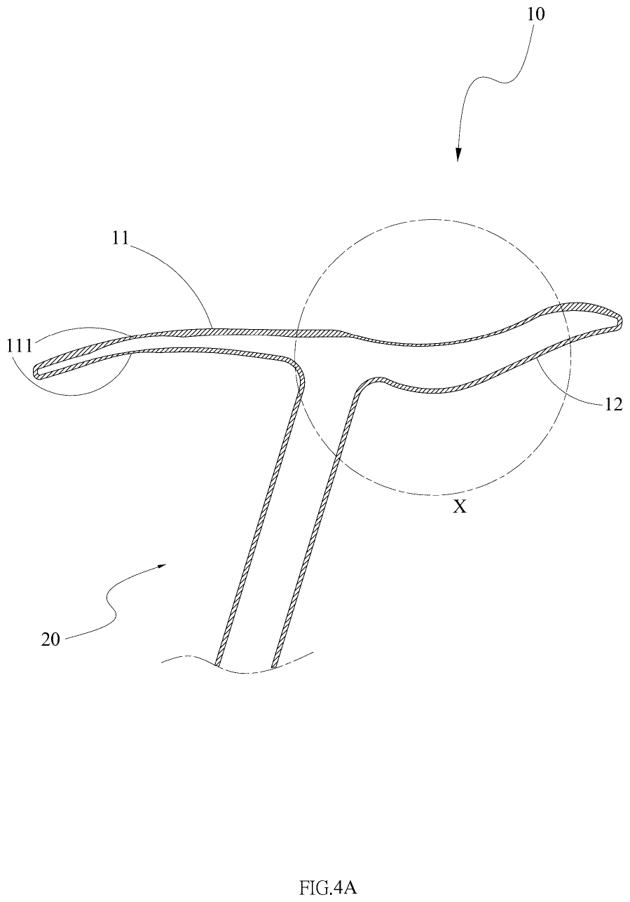

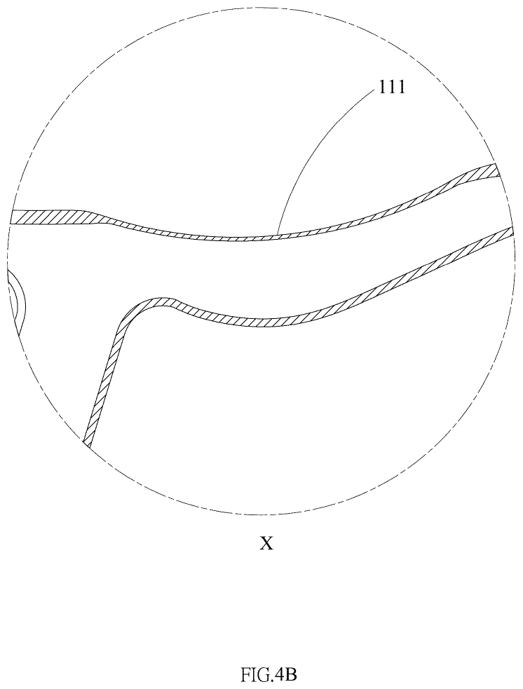

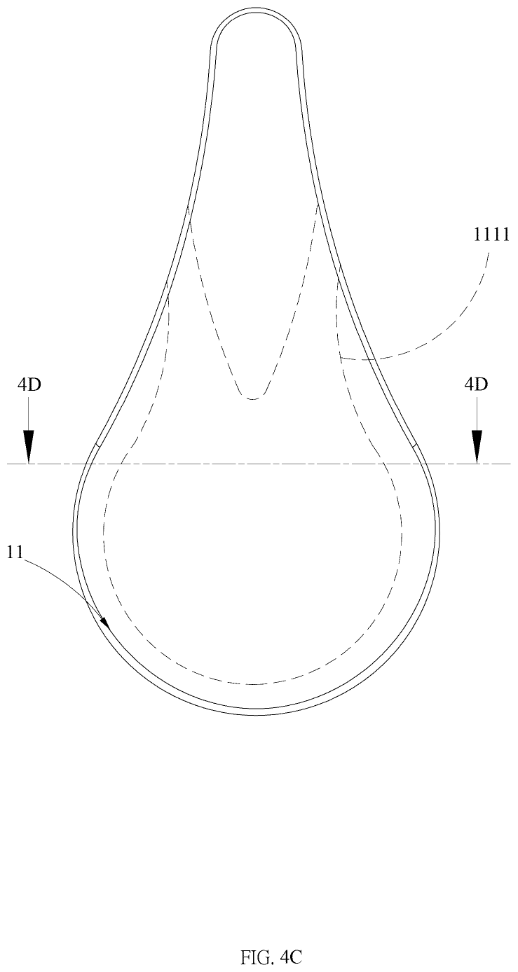

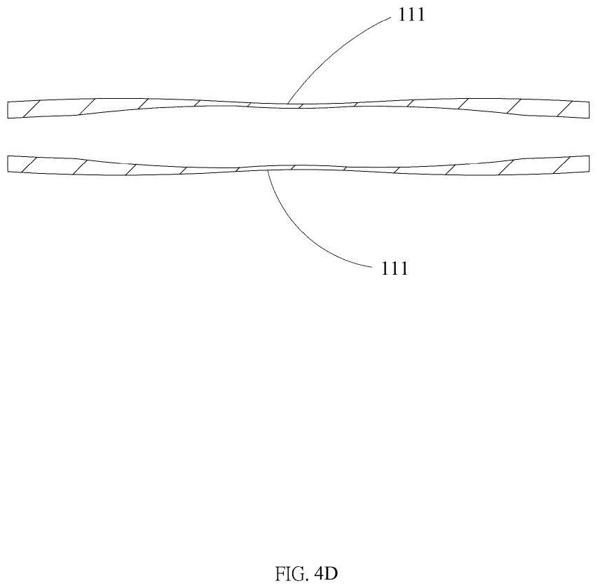

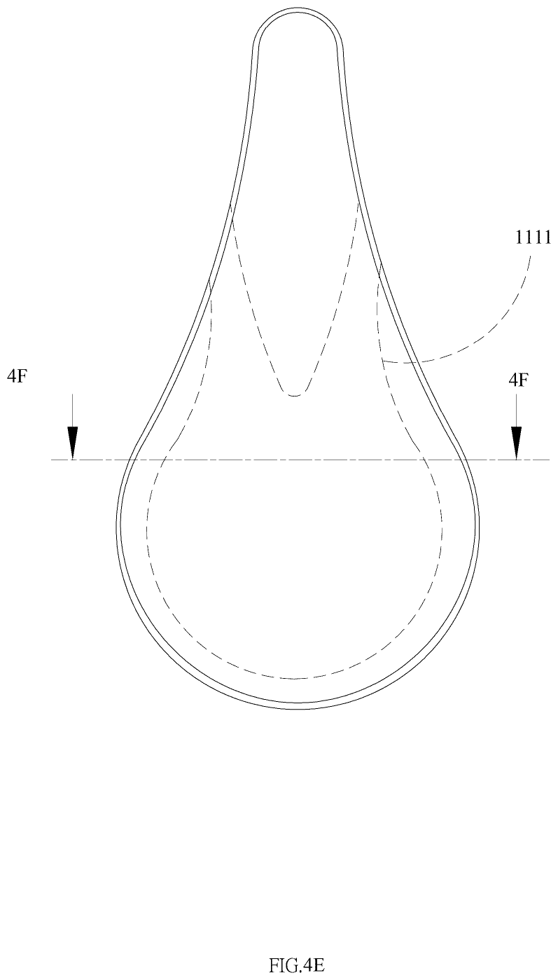

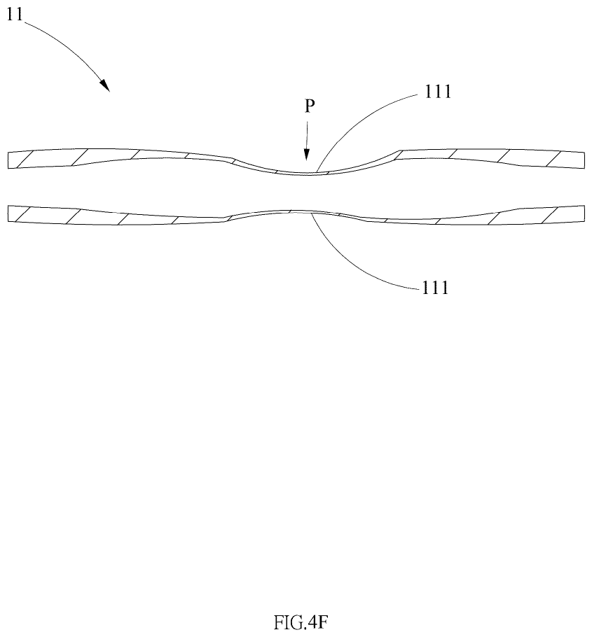

Referring to FIG. 4A to FIG. 4D, a third preferred embodiment of a bicycle saddle is disclosed. In this embodiment, the saddle part 10 further includes a thinning structure 111 formed on at least one part of the seating surface 11. The thinning structure 111 is formed by reducing an amount of the fiber prepreg laid in a corresponding area of the mold designated for the thinning structure 111 during the molding process. After compression molding, the thinning structure 111 is formed with a thickness smaller than that of other areas of the saddle part 10. Referring to FIG. 4E and FIG. 4F, when the saddle part 10 is subjected to a pressure P from the user's sitting, the pressure P makes the thinning structure 111 to be elastically deformed to fit with the user's body contour. When the pressure P is removed, the thinning structure 111 returns to an original shape thereof.

Additionally, the thinning structure 111 may also be formed by the molding process with the mold corresponding to the user's body contour.

Preferably, the thinning structure 111 is formed by inflating an airbag during the compression process. The airbag applies a pressure to the fiber prepreg to form the thinning structure 111 in correspondence with shape of the mold. The thicknesses of the thinning structure 111 and the other areas of the saddle part 10 can be precisely controlled by adjusting the pressure injected into the airbag during inflation.

Referring to FIGS. 4C to FIGS. 4F, the arrangement of the thinning structure 111 enhances a flexibility of the saddle part 10. In other words, the elastic recovery force of the thinning structure 111 not only provides excellent support for the user but also offers softness to fit with the user's body contour so as to ensure comfort during the prolonged use. In this embodiment, the thinning structure 111 is disposed along a longitudinal direction of the seating surface 11 corresponding to a straddling area 1111 on two sides of the saddle part 10. Thus, when the user applies the pressure P to the seating surface 11, the thinning structure 111 closely conforms to the user's body contour to improve riding comfort.

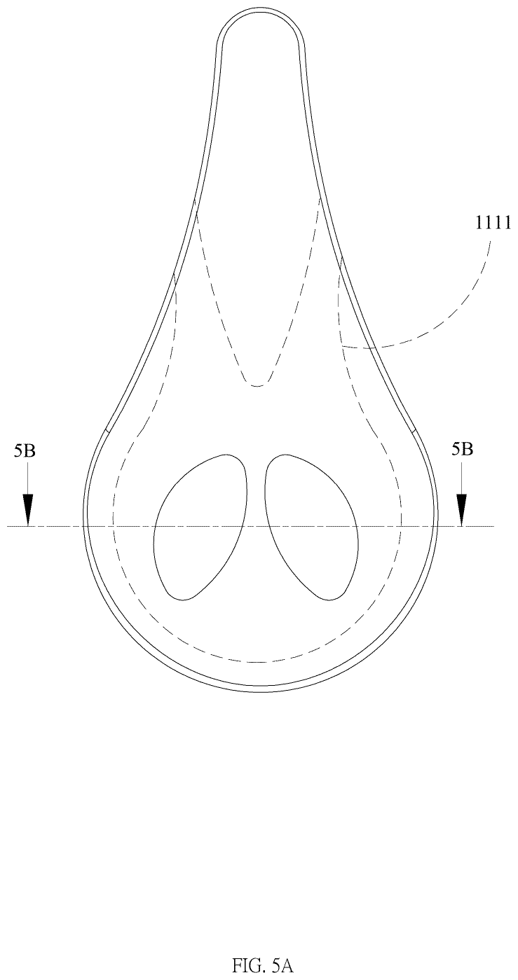

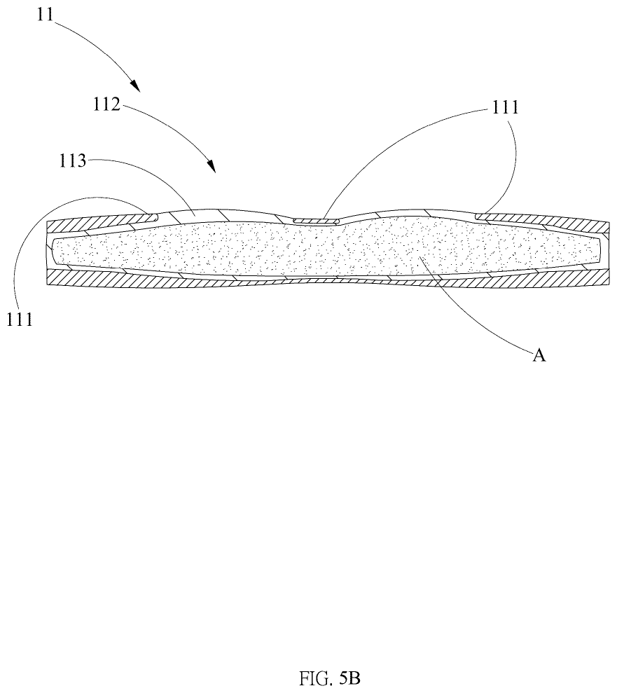

Referring to FIG. 5A and FIG. 5B, a fourth preferred embodiment of a bicycle saddle is disclosed. In this embodiment, the saddle part 10 further includes an opening 112 formed at the thinning structure 111 and an elastomer A is filled into the accommodating space through the opening 112. The elastomer A may include, but is not limited to, an air cushion or a soft pad made of a foam material. Preferably, the opening 112 is positioned at an area in contact with the user. With excellent cushioning property and breathability, the elastomer A can distribute a pressure exerted on the user's buttocks and can reduce discomfort caused by oppressive heat during a long term of riding. It not only enhances riding comfort but also reduces the amount of fiber composite material used, so that a lightweight effect for the bicycle saddle is achieved.

More preferably, the elastomer A is coated with a cladding layer 113. The cladding layer 113 includes, but is not limited to, wear-resistant synthetic leather, elastic nylon non-woven fabric, polyester fiber, polyurethane film, or high-strength polyvinyl chloride. The cladding layer 113 provides excellent wear resistance and weather resistance to prevent the elastomer A from becoming damp or polluted due to external environmental factors, thereby a service life of the bicycle saddle can be prolonged. At the same time, the elastomer A offers superior support and comfort to the user.

Furthermore, the cladding layer 113 can be replaced according to the user's riding environment to meet different functional requirements, allowing adaptation to unexpected situations during riding. For example, the user can replace the cladding layer 113 with one made of waterproof and moisture-resistant material, such as polyvinyl chloride or polyurethane, to prevent the bicycle saddle from becoming damp and damaged in humid environments or during rainfall.

Referring to FIG. 2, a reinforcing ring 121 extends from the surface of the seat tube part 20 and is deposited at the junction of the engaging surface 12 and the seat tube part 20. An outside diameter of the reinforcing ring 121 gradually increases in the direction toward the engaging surface 12.

The reinforcing ring 121 is applied to enhance the structural stability between the saddle part 10 and the seat tube part 20. For example, when the preset angle X is 60°, the seat tube part 20 tilts toward the bicycle's front wheel, make a connection between the saddle part 10 and the seat tube part 20 to form a 7-like shape.

An uneven pressure exerted by the user sitting on the saddle part 10 concentrates on a tilted area due to the preset angle X. At this point, the reinforcing ring 121 with gradually increasing the outside diameter provides more support for the connection between the saddle part 10 and the seat tube part 20 to ensure a stable connection and to prevent damage to the saddle part 10 and the seat tube part 20 caused by the uneven pressure. Additionally, the reinforcing ring 121 distributes vibrations and impacts that may occur during riding, thereby the service life of the saddle part 10 and the seat tube part 20 is prolonged and the risk of damage is reduced.

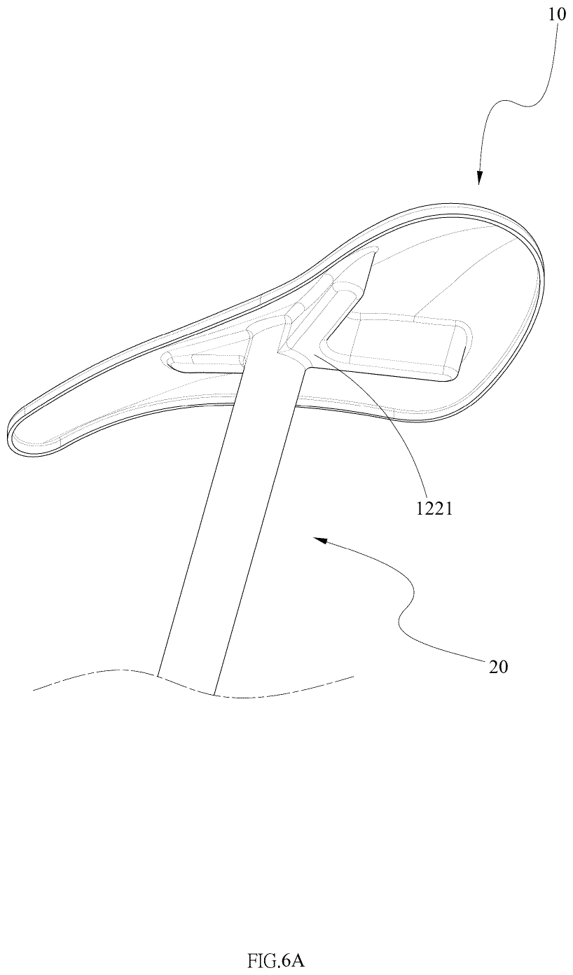

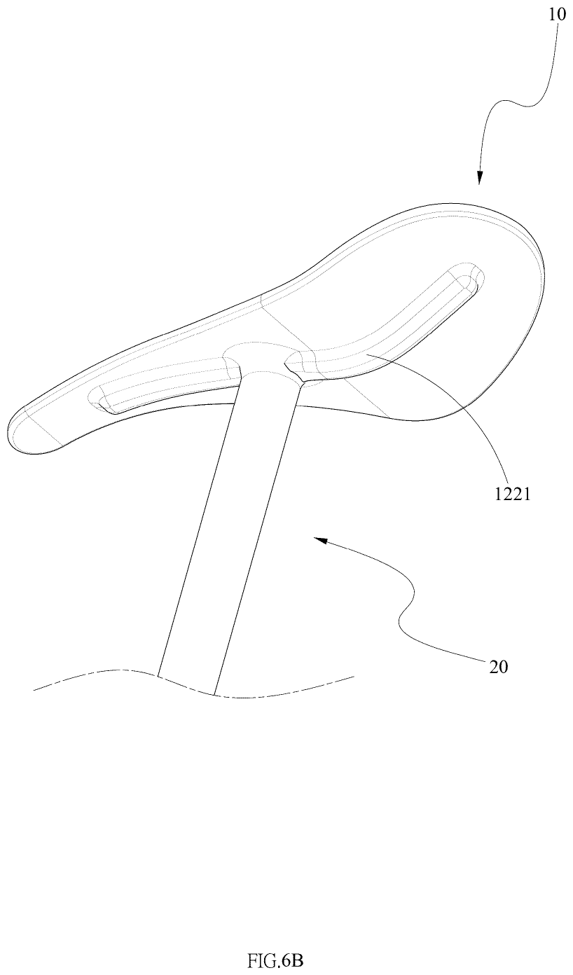

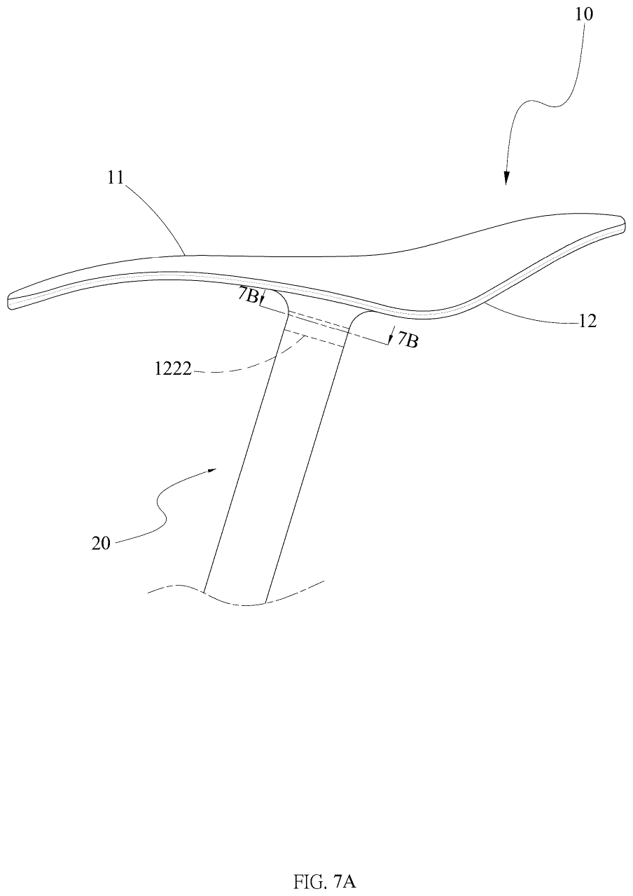

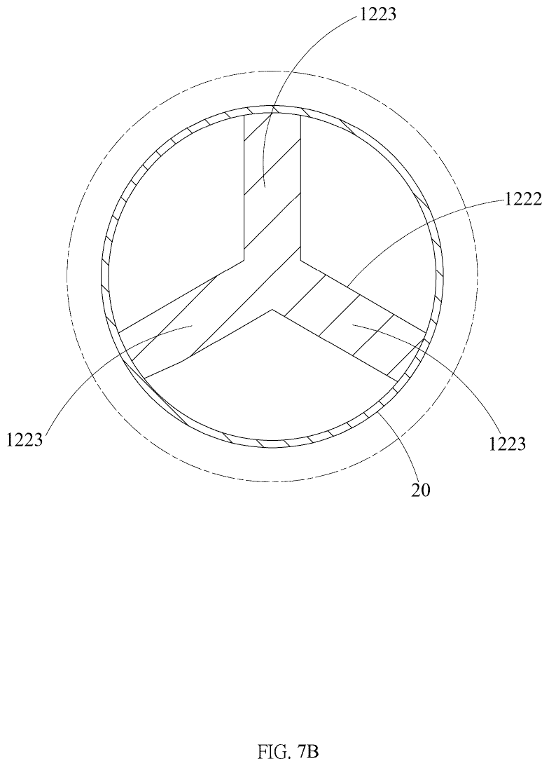

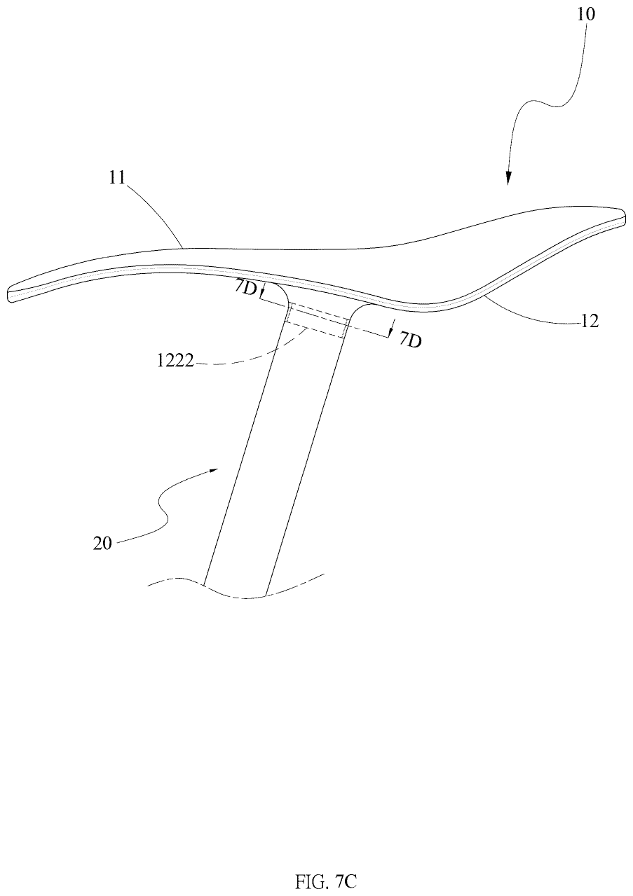

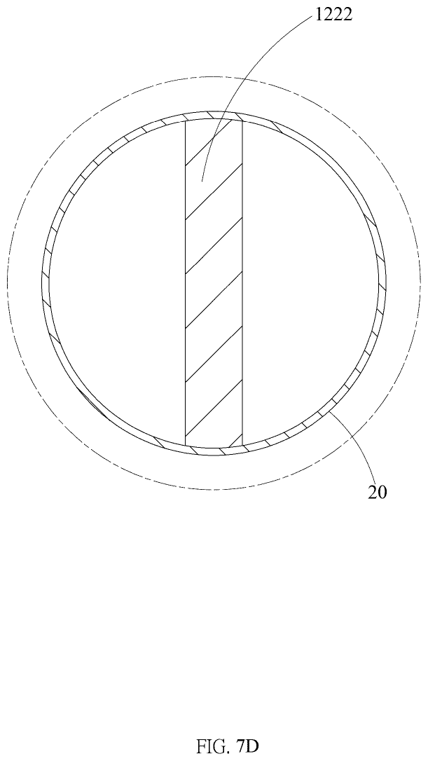

Referring to FIGS. 6A, FIGS. 6B and FIGS. 7A to 7D, preferably, the bicycle saddle further includes a reinforcing rib unit 122. The reinforcing rib unit 122 includes at least one of outer reinforcing rib 1221 and inner reinforcing rib 1222 to enhance a structural strength of the saddle part 10 and the seat tube part 20.

The outer reinforcing rib 1221 is a protrusive structure extending outward from the engaging surface 12. The outer reinforcing rib 1221 may extend in any direction from the junction between the seat tube part 20 and the engaging surface 12, or it may directly protrude from the engaging surface 12.

The inner reinforcing rib 1222 is positioned radially within the hollow tubular body of the seat tube part 20, and at least one end of the inner reinforcing rib 1222 is connected to an inner wall of the seat tube part 20. This configuration further prevents deformation of the junction between the seat tube part 20 and the engaging surface 12 caused by stress concentration due to vibrations or impacts while riding, thereby structural stability is enhanced and the service life of the bicycle saddle is prolonged.

Referring to FIG. 6A, a fifth preferred embodiment of a bicycle saddle is disclosed. In this embodiment, the reinforcing rib unit 122 includes three outer reinforcing ribs 1221. The appearance of the outer reinforcing ribs 1221 is a Y-shaped structure. When the outer reinforcing ribs 1221 form the Y-shaped structure, the outer reinforcing ribs 1221 extend in three directions respectively from the junction between the seat tube part 20 and the engaging surface 12 to form a trident-like configuration. The trident-like structure formed by the three outer reinforcing ribs 1221 enhances broad support and stability when the user sits on the saddle part 10 to distribute the weight of the user to the seat tube part 20.

Referring to FIG. 6B, a sixth preferred embodiment of a bicycle saddle is disclosed. In this embodiment, the reinforcing rib unit 122 includes two outer reinforcing ribs 1221. The outer reinforcing rib 1221 adopts a strip-like structure and extends in two opposite directions from the junction between the seat tube part 20 and the engaging surface 12 to form a strip-like configuration. Compared to the Y-shaped structure, the strip-like structure formed by the two outer reinforcing ribs 1221 requires less material during production and contributes to reduce a weight of the bicycle raddle. This design is particularly suitable for bicycles that prioritize lightweight and speed performance, such as mountain bikes and road bikes.

Referring to FIG. 7A and FIG. 7B, a seventh preferred embodiment of a bicycle saddle is disclosed. In this embodiment, the reinforcing rib unit 122 includes one inner reinforcing rib 1222 having three support arms 1223 extending radially from the central axis of the seat tube part 20 and spaced apart from each other. One end of each support arm 1223 is connected to the inner wall of the seat tube part 20.

Referring to FIG. 7C and FIG. 7D, an eighth preferred embodiment of a bicycle saddle is disclosed. In this embodiment, the reinforcing rib unit 122 has one inner reinforcing rib 1222 being rod-shaped and disposed near the junction between the seat tube part 20 and the engaging surface 12. Two ends of the inner reinforcing rib 1222 are connected to the inner wall of the seat tube part 20.

The reinforcing rib unit 122 is designed to enhance the structural stability between the saddle part 10 and the seat tube part 20 and to improve the support when the user is sitting on the saddle part 10. Additionally, the reinforcing rib unit 122 helps mitigate vibrations and impacts that may occur during riding, material fatigue and deformation risks of the bicycle saddle can be reduced and comfort for the user during riding is increased.

The appearance of the outer reinforcing rib 1221 can be designed according to the user's requirements. Further explanations regarding a customization of the appearance of the outer reinforcing rib 1221based on the user requirements will be provided in subsequent sections.

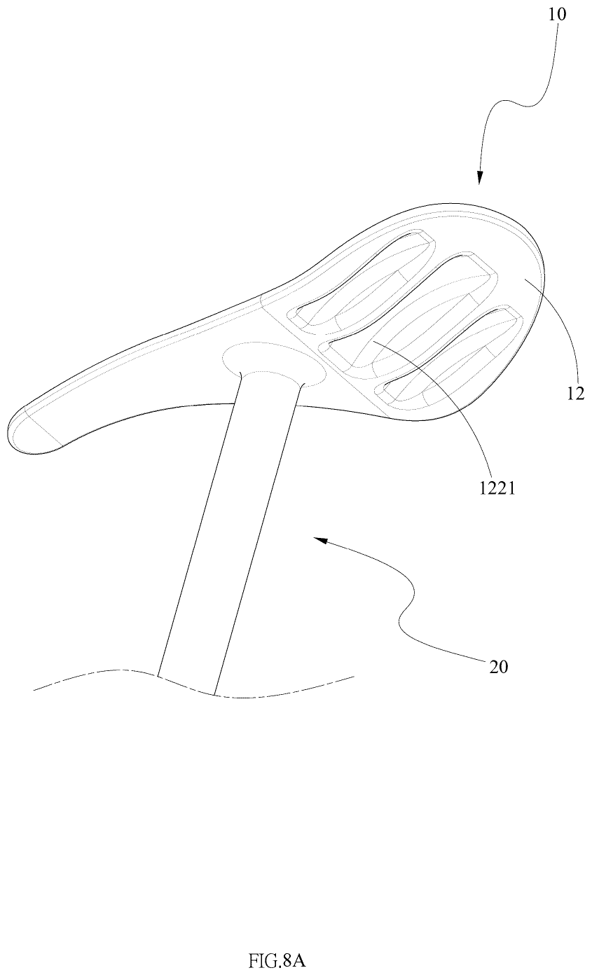

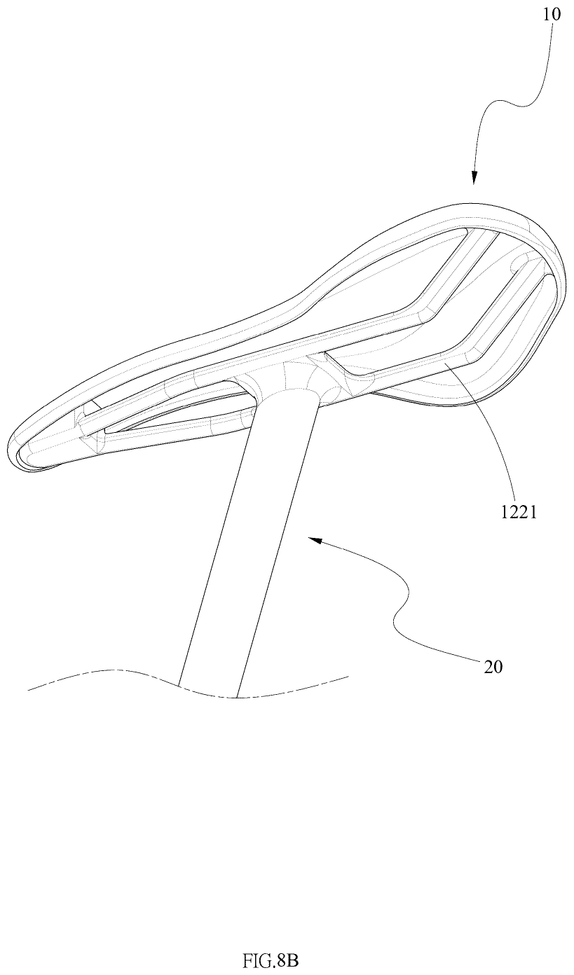

Referring to FIGS. 8A and 8B, further the reinforcing unit 122 has several outer reinforcing ribs 1221 being spaced apart from each other on the engaging surface 12. This setup of the outer reinforcing ribs 1221 helps evenly distribute a pressure exerted by the user during riding to prevent the pressure from concentrating on a specific area of the saddle part 10. By increasing the dispersion provided from the outer reinforcing ribs 1221, the risk of the pressure being applied to the specific area of the saddle part 10 is reduced.

Referring to FIGS. 8A, a nineth preferred embodiment of a bicycle saddle is disclosed. Preferably, the outer reinforcing ribs 1221 may be spaced from each other and arranged along the longitudinal direction of the saddle part 10. Furthermore, the outer reinforcing ribs 1221 may also be recessed into the engaging surface 12 in the form of grooves. The grooves not only reduce the amount of material used of the saddle part 10, to lower the weight of the saddle part 10, but also provide uniform support for the saddle part 10 to prevent overloading of pressure in specific areas.

Referring to FIG. 8B, a tenth preferred embodiment of a bicycle saddle is disclosed. In this embodiment, the reinforcing rib unit 122 includes two outer reinforcing ribs 1221. Preferably, the two outer reinforcing ribs 1221 are arranged along the longitudinal direction of the saddle part 10 and are spaced apart on two sides of the seat tube part 20. This design enhances the stability of the saddle part 10 in the longitudinal direction of the saddle part 10 by positioning the two outer reinforcing ribs 1221 on the two side of the seat tube part 20. Thus, the saddle part 10 can maintain the shape and performance thereof without deformation or instability due to a long term of use.

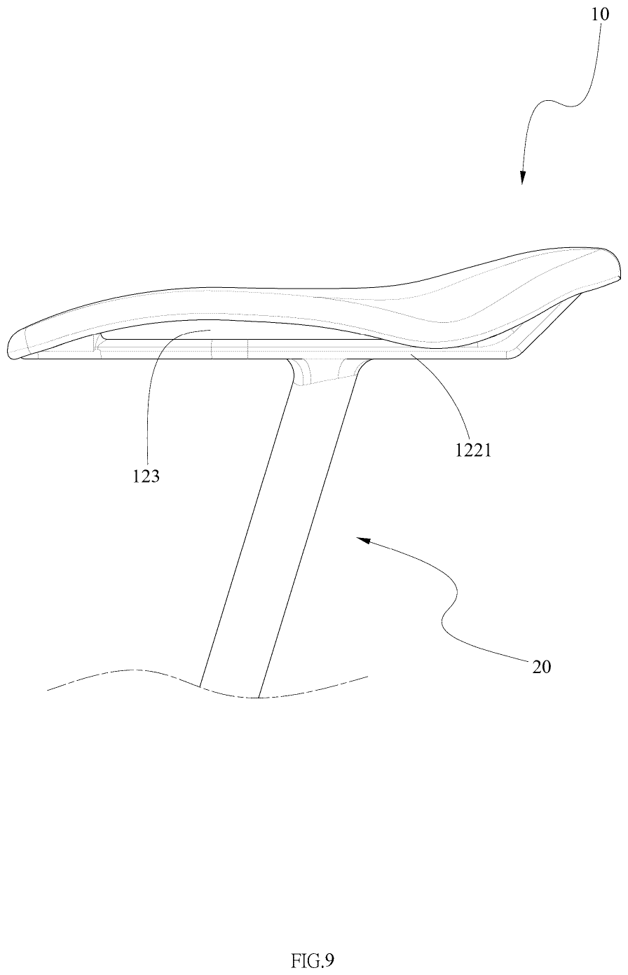

Referring to FIG. 9, an eleventh preferred embodiment of a bicycle saddle is disclosed. In this embodiment, the reinforcing rib unit 122 includes one outer reinforcing rib 1221, and the seat tube part 20 is connected to the engaging surface 12 via the outer reinforcing rib 1221. In this configuration, the outer reinforcing rib 1221 extends directly from the seat tube part 20 in any direction and is connected to the engaging surface 12 with a side opposite to the seat tube part 20. The seat tube part 20 is indirectly connected to the engaging surface 12 through the outer reinforcing rib 1221 to define a lower hollow structure 123 between the engaging surface 12 and the outer reinforcing rib 1221.

The hollow structure 123 reduces the weight of the saddle part 10 to make the bicycle equipped with the saddle part 10 lighter. Additionally, the hollow structure 123 helps mitigate vibrations and impacts caused by on uneven terrain during riding to provide improved comfort and adaptability.

What is claimed is:

1. A bicycle saddle comprising:
a saddle part comprising a seating surface, an engaging surface opposite to the seating surface and a thinning structure formed on at least one part of the seating surface; and
a seat tube part being a tubular body and connected with the engaging surface,
wherein, an accommodating space is defined in the saddle part and the seat tube part, and
the saddle part and the seat tube part are integrally formed with each other and made of a same material.

2. The bicycle saddle as claimed in claim 1, wherein the engaging surface defines a lower hollow structure.

3. The bicycle saddle as claimed in claim 1, wherein the thinning structure is disposed along a longitudinal direction of the seating surface and corresponds to a straddling area of the saddle part.

4. The bicycle saddle as claimed in claim 1, wherein the saddle part further comprises an opening formed in the thinning structure and an elastomer filled in the accommodating space via the opening and coated with a cladding layer.

5. The bicycle saddle as claimed in claim 1, wherein the saddle part further comprises a reinforcing ring deposited at a junction of the engaging surface and the seat tube part, and an outside diameter of the reinforcing ring gradually increases toward the engaging surface.

6. The bicycle saddle as claimed in claim 5, further comprises a reinforcing rib unit having at least one of outer reinforcing rib and inner reinforcing rib.

7. The bicycle saddle as claimed in claim 6, wherein the reinforcing rib unit has at least one outer reinforcing rib, the outer reinforcing rib is a protrusive structure extending outward from the junction of the engaging surface and the seat tube part.

8. The bicycle saddle as claimed in claim 6, wherein the reinforcing rib unit has several outer reinforcing ribs disposed at two sides of the seat tube part along a longitudinal direction of the saddle part.

9. The bicycle saddle as claimed in claim 6, wherein the reinforcing rib unit has at least one of inner reinforcing rib, the inner reinforcing rib is disposed radially within the tubular body of the seat tube part, and at least one end of the inner reinforcing rib connects to an inner wall of the seat tube part.

10. The bicycle saddle as claimed in claim 1, wherein a preset angle is defined between the engaging surface and the seat tube part defines.
